(19) United States
(12) Patent Application Publication
(10) Pub. No.: US 2009/0216565 A1
(43) Pub. Date: Aug. 27, 2009

(54) Method for protecting equity in purchased goods

(76) Inventor: Leon P. Opyd, III, Coal City, IL (US)

Correspondence Address: CHERSKOV & FLAYNIK;The Civic Opera Building, Suite 1447, 20 N. Wacker Drive, Chicago, IL, 60606, US

(21) Appl. No.: 12/378,129

(22) Filed: Feb. 11, 2009

Related U.S. Application Data
(63) Continuation-in-part of application No. 11/363,112, filed on Feb. 27, 2006, now abandoned.

(51) Int. Cl. G06Q 40/00

(52) U.S. Cl. 705/4

(57) ABSTRACT

A method 10 for protecting equity in purchased goods that are disposed of during a predetermined time period after purchase, includes establishing the purchase date and price for the purchased goods 14, determining a purchaser's equity in the purchased goods on the purchase date 16, selecting a time period for protecting the purchaser's equity in the purchase goods 18, determining a purchaser's equity in the purchased goods on a disposition date for the purchased goods 26, calculating the difference between the purchaser's equity and a fair market value for the purchased goods on the disposition date 30, and paying the purchaser a computer determined amount when the purchaser's equity is greater than the fair market value for the purchased goods on the disposition date 32, 40 and 42.

This is a Continuation-In-Part Application of application Ser. No. 11/363,112 filed on Feb. 27, 2006.

### BACKGROUND OF THE INVENTION

1. Field of the Invention

The present invention relates to protecting equity in purchased goods, and more particularly, to protecting the downpayment for procuring possession of a purchased vehicle during a predetermined time period.

2. Background of the Prior Art

A purchaser of goods, vehicles in particular, typically pays a downpayment and procures financing to complete the purchase transaction and procure possession of the goods or vehicle on the date of sale. The purchaser's downpayment is usually the purchaser's equity in the purchased products; although, the purchaser's equity can be greater or less than the downpayment when purchasing products with unknown or difficult to determine fair market values. Generally, an insurance policy (“Gap Insurance”) is also procured on the sales date to obtain possession of the goods or vehicle. An up-front one time payment is made by the purchaser to procure the Gap Insurance policy which protects the finance company and/or purchaser in the event that the goods or vehicle are damaged. When the goods or vehicle are damaged such that the cost of repair is greater than the fair market value of the goods or vehicle, the Gap Insurance pays the finance company a dollar amount equal to the loan balance minus the fair market value of the goods or vehicle in an undamaged condition on the date of damage.

A problem occurs when the goods or vehicle depreciate relatively fast after purchase, and the goods or vehicle become damaged, lost, stolen or sold within a relatively short time period after purchase, resulting in a substantially reduced fair market value for the goods or vehicle. The depreciation of the goods or vehicle results in the purchaser losing a corresponding portion of his or her downpayment when payments are received to compensate the purchaser for the loss of the goods or vehicle. Thus, the purchaser is forced to raise more funds to purchase a replacement vehicle or goods that, from the purchaser's perspective, perform the same function and are of equal value, from the purchaser's viewpoint, to the original products. These common results pertaining to damaged, lost, stolen or sold goods or vehicles are unfair to the purchaser.

A need exists for a method for protecting, on the purchase date, the purchaser's downpayment and/or equity in the purchased goods or vehicle in the event that the goods or vehicle are damaged, lost, stolen or sold. The method must allow the purchaser to select on the purchase date, a time period to protect his or her equity in the purchased goods or vehicle. Further, the method must allow the purchaser to determine on the purchase date, a reasonable amount of money that he or she will receive for any day during the selected time period that the goods or vehicle are lost, stolen, damaged or sold. Also, the method must provide the parameters for procuring an insurance policy for the purchaser's benefit to guarantee the amount of money the purchaser is to receive in the event the goods or vehicle are damaged, stolen, lost or sold during the selected time period.

### SUMMARY OF THE INVENTION

It is an object of the present invention to overcome many of the disadvantages associated with protecting equity in purchased goods that are damaged with a predetermined time period after purchase. It is another object of the present invention to overcome many of the disadvantages associated with protecting equity and/or downpayment in purchased vehicles that depreciate in value relatively quickly after purchase.

A principal object of the present invention is to provide a method that allows a purchaser of goods to determine his or her equity in the purchased goods on the purchase date. A feature of the method is that the purchaser's equity in the purchased goods determined on the purchase date, is negotiated between the purchaser and an insurance company, the insurance ultimately issuing an insurance policy that guarantees the determined purchaser's equity in the purchased goods. An advantage of the method is that the dollar amount of the determined purchaser's equity in the purchased goods is based on a reasonable value that the goods provide to the purchaser rather than a typical fair market value.

Another object of the present invention is to provide a method that allows a purchaser on the purchase date of the goods to select a time period for protecting the determined purchaser's equity in the purchased goods. A feature of the method is that on the purchase date of the goods, the purchaser's equity in the purchased goods is set for a time period that the purchaser excepts to own the purchased goods. An advantage of the method is that the purchaser's equity in the purchased goods is not reduced over time due to depreciation parameters.

Another object of the present invention is to provide a method that determines a purchaser's equity in the purchased goods on a damage or sales date for the purchased goods. A feature of the method is that on the purchase date of the goods, the purchaser's equity in the purchased goods is determined for each day of the selected time period. An advantage of the method is that on the purchase date of the goods, the purchaser knows the dollar amount he or she will receive for the purchased goods in the event the purchased goods are sold or damaged during the selected time period.

Another object of the present invention is to provide a method that calculates the difference between the purchaser's equity and a fair market value for the purchased goods on the damage or sales date. A feature of the method is that a computer ultimately determines the purchaser's equity in the purchased goods based upon a negotiated amount between the purchaser and an insurance company, or is based upon an algorithm agreed upon by purchaser and insurance company, then entered into the computer. Another feature of the method is that a fair market value for the purchased goods on a damage or sales date is entered into the computer. An advantage of the method is that the computer quickly determines the dollar amount the purchaser is to be paid based upon the purchaser's equity in the purchased goods on the damage or sales date of the purchased goods.

Briefly, the invention provides a method for protecting equity in purchased goods that are damaged within a predetermined time period after purchase, said method comprising the step of establishing the purchase date and price for the purchased goods; determining a purchaser's equity in the purchased goods on the purchase date; selecting a time period for protecting said purchaser's equity in the purchased goods; determining a purchaser's equity in the purchased goods on a damage, lost, stolen or sales date for the purchased goods; calculating the difference between said purchaser's equity and a fair market value for the purchased goods on the damage or sales date; and paying the purchaser a computer determined amount when said purchaser's equity is greater than the fair market value for the purchased goods on the damage or sales date.

The invention further provides a method for maintaining equity in a vehicle for a predetermined time period after purchasing the vehicle, said method comprising the steps of recording the purchase date and price of the vehicle; recording the amount paid by a purchaser of the vehicle on the purchase date; determining a time period for maintaining a purchaser's equity in the vehicle; calculating said purchaser's equity for the vehicle on a selected day during said time period; and paying the purchaser a computer determined amount.

The invention further provides a method for insuring a purchaser's downpayment when purchasing a vehicle, said method comprising the steps of entering vehicle purchase parameters into a computer; entering a vehicle ownership time period into said computer; calculating via said computer, a purchaser's equity in the vehicle over said ownership time period; and paying an insurance premium to an insurance company to insure said calculated purchaser's equity in the vehicle over said ownership time period whereby the purchaser receives a payment from the insurance company in the event that the fair market value of the vehicle is insufficient for the purchaser to receive a calculated equity on a date, within said ownership time period, that the vehicle is sold, lost, stolen or damaged.

### BRIEF DESCRIPTION OF THE DRAWINGS

These and other objects, advantages and novel features of the present invention, as well as details of an illustrative embodiment thereof, will be more fully understood from the following detailed description and attached drawings, wherein:

FIG. 1 is a flow chart depicting a method for protecting equity in purchased goods that are damaged or sold within a predetermined time period after purchase.

FIG. 2 is a flow chart depicting an alternate method for protecting a downpayment or equity in purchased goods or real estate that are damaged, lost, stolen or sold within a selected time period after purchase.

### DESCRIPTION OF THE PREFERRED EMBODIMENT

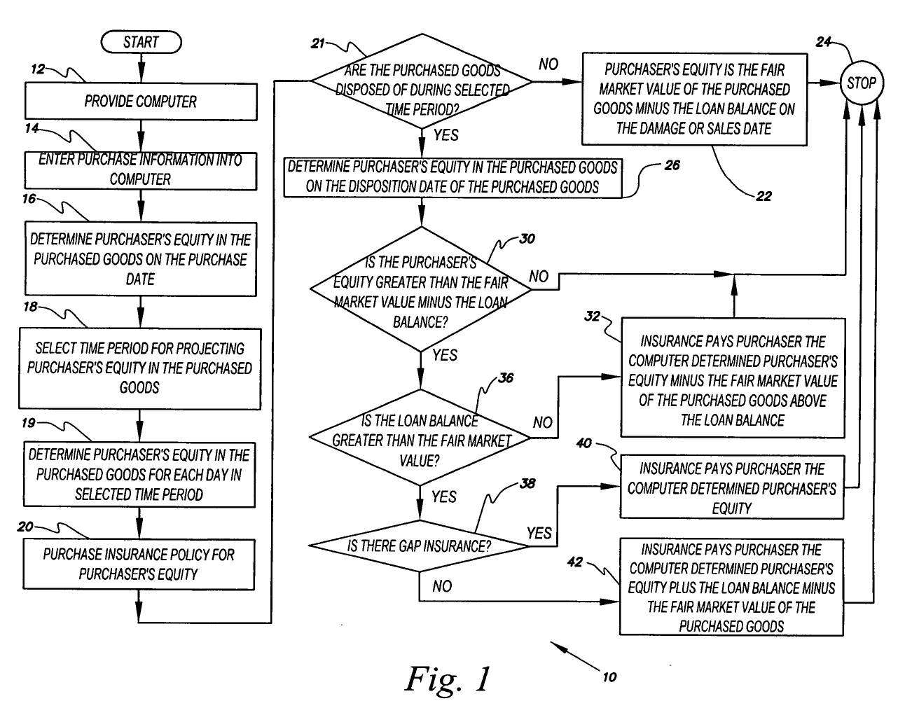

Referring now to the flow chart of FIG. 1, a method for protecting equity or a purchaser's downpayment in purchased goods that are damaged, lost, stolen, traded, sold or otherwise disposed of within a predetermined time period after purchase is denoted by numeral 10. The purchaser's downpayment includes but is not limited to cash, rebates, trade items “trade-ins,” services, leases or combinations thereof. More specifically, the method 10 protects the purchaser's downpayment from being lost or reduced due to depreciation of the purchased goods over a relatively short period of time. Typically, when goods, especially vehicles, are purchased, the depreciation can cause the fair market value (which is determined via methods well known to those of ordinary skill in the art) of the vehicle to be less than the amount required to finance the purchase. Generally, an insurance policy is procured that protects (irrespective of depreciation) a finance company's loan amount required to purchase the vehicle, however, there is no insurance policy in place that protects the purchaser's equity or downpayment.

Referring now to block 12, a computer is utilized to receive information pertaining to purchased goods, and in particular, to information pertaining to a purchased vehicle. The computer can be a desk-top or lap-top, both well known to those of ordinary skill in the art. Information pertaining to the purchased goods, is entered into the computer pursuant to block 14, the information includes parameters that represent the goods fair market value. For a purchased vehicle, information or parameters representing fair market value that are “fed” into the computer includes but is not limited to the year, make and model number of the vehicle, and the mileage, condition and general performance of the vehicle.

After providing information pertaining to purchased goods to the computer, the purchaser determines his or her equity in the purchased goods on the purchase date pursuant to block 16. Generally, the purchaser's equity in the purchased goods on the day of purchase will be the fair market value of the purchased goods minus the loan or financing required to purchase the goods, which should equal the downpayment the purchaser advances to the seller for possession of the purchased goods. However, if the purchased goods have a fair market value greater or lower than the downpayment added to the funds borrowed to purchase the goods, then the purchaser's equity in the purchased goods will be correspondingly greater or lower than the downpayment. Irrespective of the fair market value of the purchased goods at the time of purchase, the objective is to establish the purchaser's equity in the purchased goods at the time of purchase at a dollar amount equal to or greater than the downpayment. The purchaser's equity at the time of purchase is entered into the computer.

Referring now to block 18, a time period is selected for protecting equity in the purchased goods, the time period being entered into the computer. The time period is provided by the purchaser and is based upon an estimated time period that the purchaser expects to own the purchased goods, or is based upon a time period corresponding to the useful life of the purchased goods, or is set via negotiations between the purchaser and an insurance company. After selecting a time period for protecting equity in the purchased goods, the purchaser's equity in the purchased goods is determined for each day during the selected time period thereby establishing a constant or time varying equity dollar amount for the purchased goods in the event the goods are damaged, lost, stolen or sold during the selected time period (block 19).

Referring now to block 20, the purchaser then pays a one time “up-front” insurance premium to the insurance company for an insurance policy to insure the purchaser's equity in the purchased goods over the selected time period, whereby the purchaser receives a predetermined payment from the insurance company in the event that the fair market value of the purchased goods or vehicle is insufficient for the purchaser to receive a predetermined or established equity dollar amount on a date, within the selected time period, that the purchaser disposes of the purchased goods. The predetermined payment to cover lost equity or downpayment is based upon an insurance premium payment made by the purchaser to insure a predetermined amount of downpayment or equity over a selected time period. The protected equity amount may be greater, equal to or less than the downpayment or initial equity on the purchase date; however, the typical purchaser procured insurance policy protects an equity amount that decreases via a prorated or accelerated rate over the selected time period.

Referring to decision block 21, if the purchaser maintains ownership of the purchased goods in an undamaged condition for a time period greater than the selected time period, then the purchaser's equity in the purchased goods equals the fair market value minus the loan balance of the purchased goods (block 22), and the method for protecting the purchaser's equity in the purchased goods terminates (block 24).

Returning to decision block 21, if the purchased goods are sold, lost, stolen or damaged before the selected time period is achieved, then the purchaser's equity in the purchased goods in an undamaged condition is determined by the computer for the date the purchased goods are sold, lost, stolen or damaged (“the disposition date”—block 26). On the day of purchase, the purchaser's equity in the purchased goods is the downpayment. Further, on the day of purchase, the purchaser decides if his or her equity in the purchased goods will have a constant value (equal to or less than the downpayment) during the entire selected time period. Alternatively, the purchaser may decide to have the equity diminish (as determined by a computer algorithm well known to those of ordinary skill in the art) during the preselected time period, whereupon, the purchaser procures a corresponding insurance policy that guarantees the decided upon equity. The purchaser's insurance premium will ultimately be based upon the purchaser's choice of equity protection for the purchased goods over the selected time period. The one time, up-front insurance premium, which may include several payments made on and/or after the purchase date, corresponds to the insurance payment that may be made by the insurance company or provider to the purchaser on a date subsequent to the vehicle purchase date.

The computer ultimately determines the equity for the purchased goods for each day within the selected time period. The computer sets the daily equity value, which may or may not decrease over time based upon an algorithm corresponding to the depreciation of the purchased goods, via a program that assigns a dollar value to the purchased goods for each day during the preselected time period; the purchaser and the insurance company having agreed to the program daily dollar amounts when the purchaser pays the up-front insurance premium.

Referring now to decision block 30, after the computer determined the purchaser's equity in the purchased goods on the damage or disposition date, if the purchaser's equity is equal to or less than the fair market value minus the loan balance of the purchased goods, then the purchaser receives the purchased goods fair market value minus the loan balance, and the method 10 for protecting the purchaser's equity terminates (block 24). If the purchaser's equity is greater than the fair market value minus the loan balance (decision block 30), then the purchaser is paid by the insurance company the purchaser's equity minus the fair market value above the loan balance (block 32). In the event that the loan balance is greater than the fair market value of the purchased goods (decision block 36), a “gap” insurance policy pays off the amount of loan balance above the fair market value (decision block 38), and the insurance company pays the purchaser the computer determined purchaser's equity (block 40). If the loan balance is greater than the fair market value of the purchased goods (decision block 36) and there is no gap insurance policy (decision block 38), then the insurance company pays the purchaser the computer determined purchaser's equity plus the loan balance minus the fair market value of the purchased goods (block 42); the purchaser's net dollar amount being the purchaser's equity as determined by the computer.

In operation, a purchaser of goods (vehicles in particular) pays a downpayment predetermined up-front amount of money or value via trade, services or rebate. The purchaser requires that a predetermined portion of the money or trade value be protected over a preselected time period thereby maintaining a calculable amount of owner's equity in the purchased goods for any selected day during the preselected time period. Thus, the purchaser knows exactly what amount of money he or she will receive for the purchased goods in the event the goods are damaged or sold during the time period, irrespective of the fair market value of the purchased goods or the remaining loan balance on the goods on the damage or sales date.

The purchaser's equity or downpayment in the purchased goods that are damaged within a predetermined time period, is protected via a method 10 that includes providing a desk-top or lap-top computer 12. Information pertaining to the purchased goods is fed in the computer thereby enabling the computer to calculate the purchaser's equity in the goods on the day of purchase 16. The purchaser then selects a time period 18 for protecting his or her equity in the purchased goods. The selected time period is entered into the computer. The purchaser then determines the amount of equity to be maintained in the purchased goods for each day of the selected time period 19. The equity amount for each day during the selected time period is entered into the computer, alternatively, an algorithm for determining the equity amount for each day during the selected time period is entered into the computer. The purchaser then pays a one time up-front insurance premium 20 to an insurance company for an insurance policy to insure the purchaser's equity in the purchased goods for a predetermined amount for each day during the selected time period.

Referring to decision block 21, if the purchased goods are sold, lost, stolen or damaged after the selected time period, then the purchaser receives nothing form the insurance company and is left with the fair market value of the purchased goods minus the outstanding loan balance (block 22). If the purchased goods are sold, lost, stolen or damaged during the selected time period, then the purchasers equity in the purchased goods for the sales or damage date is determined by the computer (block 26).

After the computer determines the purchaser's equity in the purchased goods on the damage or disposition date, if the computer determined purchaser's equity is equal to or less than the fair market value minus the loan balance of the purchased goods on the damage or disposition date (decision block 30), then the purchaser receives the purchased goods fair market value minus the loan balance. More specifically, the purchaser receives no payment from the insurance company and the method of protecting the purchaser's equity stops (block 24). If the computer determined purchaser's equity is greater than the fair market value minus the loan balance on the damage or disposition date (decision block 30), then the purchaser is paid by the insurance company the computer determined purchaser's equity minus the fair market value of the purchased goods above the loan balance (block 32).

The purchaser ultimately receives their equity in the purchased goods via an insurance policy or by selling damaged goods. Proceeds from the insurance policy or the sold damaged goods are used first to pay the loan balance. The remaining proceeds are retained by the purchaser. If the loan balance is greater than the fair market value of the purchased goods (block 36), and if there is a gap insurance policy (block 38), the purchaser is paid a computer determined purchaser's equity (block 40); if there is no gap insurance policy (block 38), the purchaser is paid a computer determined purchaser's equity plus the loan balance minus the fair market value of the purchased goods (block 42).

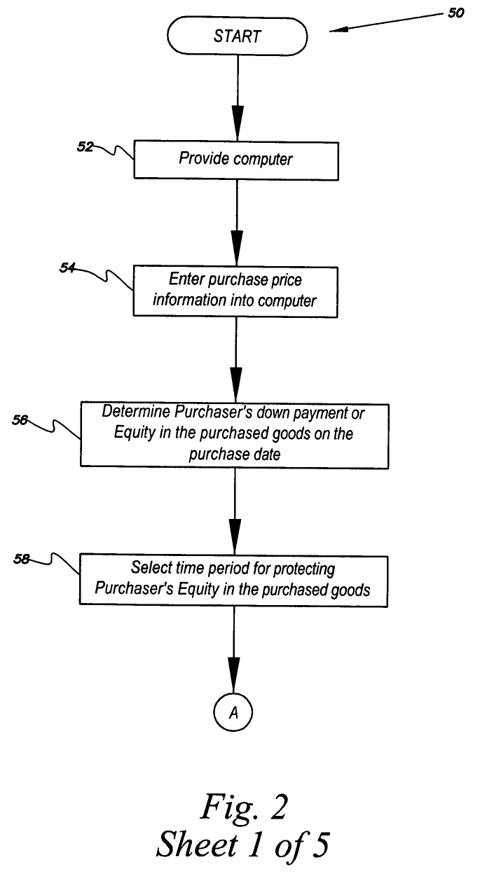

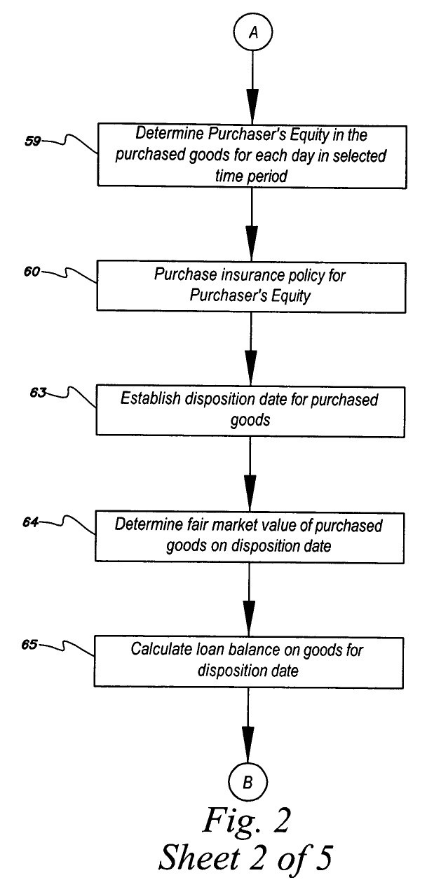

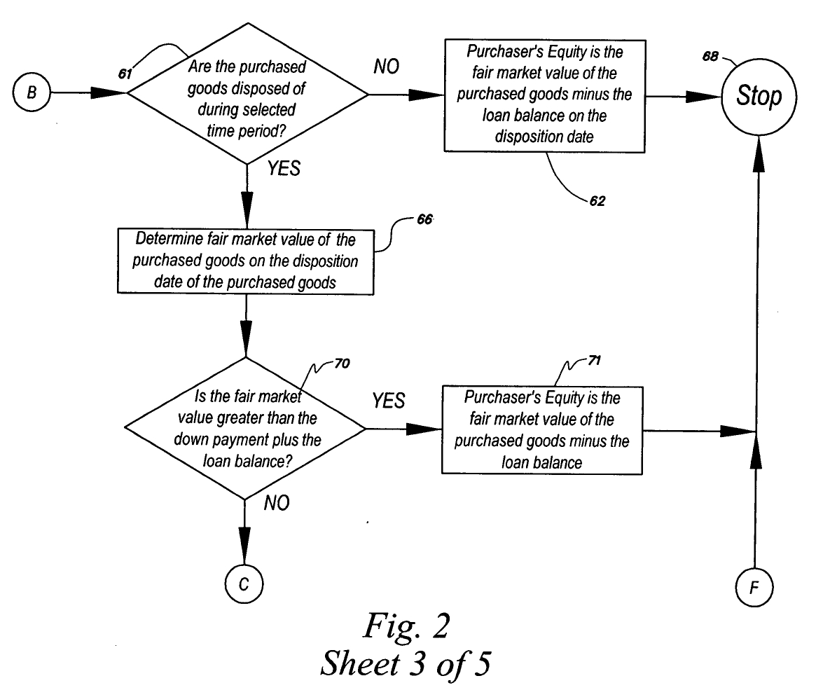

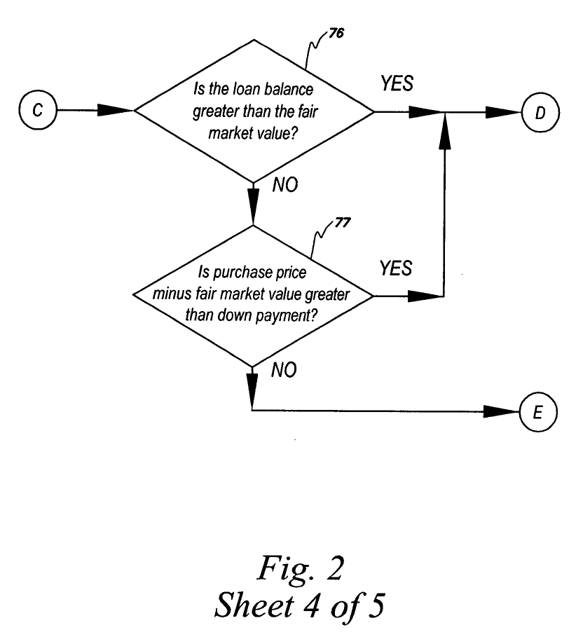

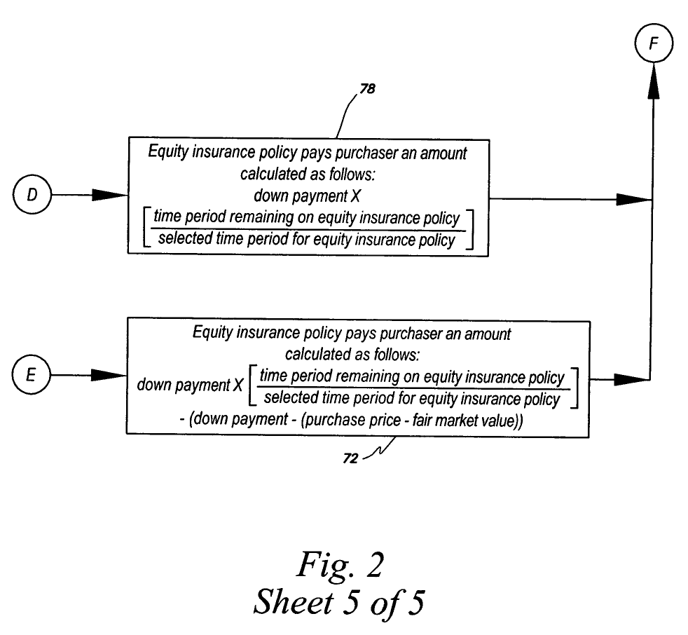

Referring now to FIG. 2, a flow chart is provided that depicts an alternate method for protecting a purchaser's downpayment or equity payment made on the purchase date for goods, real estate or other items that the purchaser bought via a loan is denoted as numeral 50. FIG. 2 includes providing a computer (block 52), entering purchase price information into the computer (block 54), determining the purchaser's downpayment or equity in the purchased goods on the purchase date (block 56), selecting a time period for protecting purchaser's downpayment or equity in the purchased goods (block 58), determining purchaser's equity in the purchased goods for each day in the selected time period (block 59) based upon prorated or accelerated declining rates for each day during the selected time period, purchasing insurance to protect the purchaser's downpayment or equity (block 60), establishing a disposition date for the purchased goods (block 63) during the selected time period, determining the fair market value of the purchased goods on the disposition date (block 64), and calculating the loan balance on the goods for the disposition date (block 65).

A decision is then made (block 61) to determine if the purchased goods have been disposed of during the selected time period. If the goods have not disposed during the selected time period, then purchaser's equity is the fair market value of the purchased goods minus the loan balance (block 62), and the method ends 68. If the goods have been disposed of during the selected time period, then the method 50 determines the fair market value of the purchased goods on the disposition date of the purchased goods (block 66), and ultimately calculates how much of the purchaser's initial equity or downpayment for the purchased goods will be refunded to the purchaser by proceeding to block 70.

Block 70 determines if the fair market value of the purchased goods is greater than the downpayment plus the loan balance. If the fair market value is greater, then the purchasers equity or remaining downpayment is the fair market value minus the loan balance (block 71) and no equity insurance payments are made. If the fair market value is less than the downpayment plus the loan balance (block 70), then it must be determined if the loan balance is greater than the fair market value (block 76). If the loan balance is not greater than the fair market value, then the method 50 continues to block 77 to determine if the purchase price minus the fair market value is greater than the downpayment. If the purchase price minus the fair market value is not greater than the downpayment (block 77), then the equity insurance policy pays the purchaser an amount determined as follows (block 72):

Downpayment×(time period remaining on equity insurance policy/selected time period for equity insurance policy)−(Downpayment−(Purchase price−Fair Market Value))

Referring to block 76, if the loan balance is greater than the fair market value, or if pursuant to block 77, the purchase price minus the fair market value is greater than the downpayment, then the equity insurance policy pays the purchaser an amount determined as follows (block 78):

Downpayment×(time period remaining on equity insurance policy/selected time period for policy)

The following examples illustrate the invention:

### EXAMPLE 1

Purchaser 1 purchases a $25,000 automobile by making a downpayment of $10,000 and financing $15,000 to be repaid in 60 months. Purchaser 1's equity in the automobile on the purchase date is $10,000. Purchaser 1 then purchases an insurance policy to protect the downpayment (purchaser's equity) for a selected time period of 3 years. The cost of the insurance policy is ultimately set by an insurance company. The insurance policy provides that the insurer will pay purchaser 1 the difference between the downpayment ($10,000) and a pro-rated amount from the time the insurance policy was purchased until the expiration of the 3 year time period.

After 2 years, the automobile is involved in an accident and is considered a total loss with no value. $14,000 is still owed on the originally financed $15,000. The fair market value (“FMV”) is less than the downpayment plus the loan balance (block 70), and the loan balance is greater than the FMV (block 76); therefore, the equity insurance policy pays automobile purchaser 1: $10,000×(⅓) or $3,333.33 (block 78), which corresponds to the 1 year remaining on the 3 year time span selected for downpayment protection.

Alternatively, if the purchaser paid higher premiums, the insurance policy could provide that the insurer will pay purchaser 1 all of the downpayment, i.e., $10,000, irrespective of when the automobile is reduced to $0.00 during the 3 year time period.

### EXAMPLE 2

Purchaser 2 purchases a $25,000 automobile by making a downpayment of $10,000 and financing $15,000 to be repaid in 60 months. Purchaser 2 purchases an insurance policy to protect the downpayment for 3 years.

After 2 years, the automobile is sold by purchaser 2 for a fair market value of $11,000. $14,000 is still owed on the originally financed $15,000. The fair market value is less than the downpayment plus the loan balance (block 70), and the loan balance is greater than the fair market value (block 76); therefore, the equity insurance policy pays purchaser 2 an amount calculated as follows (block 78): $10,000×(⅓) or $3,333.33.

### EXAMPLE 3

The same facts as Example 2 except that after 2 years, the automobile is sold by Purchaser 2 for a fair market value of $17,000. The purchase price ($25,000) minus the sales price ($17,000) results in $2,000 remaining of the $10,000 downpayment. The $2,000 must be subtracted from any equity insurance payment made, which is provided for in FIG. 2.

Referring to FIG. 2, the fair market sales value is less than the downpayment plus the loan balance (block 70), but the loan balance is less than the fair market value (block 76). Referring to block 77, the purchase price minus the fair market value is less than the downpayment; therefore, the equity insurance policy pays Purchaser 2 an amount calculated as follows (block 72):

$10,000×(⅓)−($10,000−($25,000−$17,000)) or $3,333.33−$2,000=$1,333.33

Obviously, if the purchase price and fair market value numbers resulted in a negative number calculation of block 72, Purchaser 2 would be paid nothing.

If the automobile was sold for $5,000 and the loan balance was $4,000, then the purchase price minus the fair market value ($25,000−$5,000=$20,000) is greater than the downpayment (block 77); therefore, the equity insurance policy pays Purchaser 2 an amount calculated as follows (block 78): $10,000×(⅓)=$3,333.33

### EXAMPLE 4

Purchaser 4 coming out of bankruptcy purchases a $25,000 automobile via a downpayment gift from his father of $5000, and financing of $20,000 to be repaid over 7 years at 14% interest. The $5,000 downpayment is protected by an equity insurance policy that covers a 5 year time period. Further, collision insurance on the auto and gap insurance on the loan are procured. One year after purchasing the automobile, Purchaser 4 involves the automobile in a collision that reduces the automobile's value to salvage in a junkyard. The fair market value of the auto at the time of the collision is $15,000. The balance owed on the loan is $19,100. Thus, the fair market value after the collision is less than the downpayment plus the loan balance (block 70), and the loan balance is greater than the fair market value (block 76) after the collision. The equity insurance has 4 years remaining for protecting the $5,000 downpayment, resulting in $5,000×(⅘) or $4,000 (block 78) being paid to Purchaser 4 on the equity insurance policy. Further, the collision insurance pays Purchaser 4 the fair market value ($15,000) of the auto, and the gap insurance pays the loan amount that is greater than the fair market value ($19,100−$15,000=$4,100). Thus, the equity insurance pays Purchaser 4 independent of the gap and collision insurance policies.

### EXAMPLE 5

The same facts as Example 4 except that the fair market value of the auto at the time of the collision is $19,500. Therefore, the fair market value is greater than the loan balance ($19,100) before the collision. The collision insurance pays Purchaser 4 the fair market value ($19,500), but $19,100 is used to payoff the loan leaving $400 for Purchaser 4. Since the fair market value ($19,500) plus the downpayment ($5,000) is less that the purchase price ($25,000), Purchaser 4 still receives payment for the 4 remaining years on the equity insurance policy, a total of $4,000.

### EXAMPLE 6

The same facts as example 4 except that the fair market value of the auto at the time of the collision has increased to $30,000. Therefore, the fair market value is greater than the downpayment ($5,000) plus the loan balance ($19,100) (block 70). The fair market value provides Purchaser 4 with $10,900 worth of equity in the auto (block 71). After the auto collision, the collision insurance would payoff the loan, and would pay Purchaser 4 $10,900 if the insurance contract included a rider that covers the increased value of the auto. Obviously, no gap insurance or equity insurance payments would be made.

If no rider was included, then the collision insurance would pay out a total of $25,000 representing the purchase price of the auto. Again, no gap insurance or equity insurance payment would be made. If something less than $25,000 was paid by the collision insurance, say $22,000, then no gap insurance would be paid, the loan would be paid in full, but the fair market value of the auto would be considered $22,000, and pursuant to block 70, the fair market value is now less than the downpayment plus the loan balance. Further, the loan balance is less than the fair market value (block 76) and the purchase price minus the fair market value is less than the downpayment, pursuant to block 72, the equity insurance policy would pay Purchaser 4 an amount calculated as follows:

$5,000×(⅘)−($5,000−($25,000−$22,000))=$4,000−$2,000 or $2,000.

### EXAMPLE 7

Purchaser 5 purchased downpayment or equity insurance on a new home for a 10 year time period. Purchaser 5 makes a downpayment of $50,000 on the home that includes a $200,000 purchase price and a $150,000 mortgage. Purchaser 5's housing market area has dropped in value and his home value has decreased from $200,000 to $175,000. Purchaser 5's home catches on fire and is completely destroyed one year after purchase. The loan balance is $148,500. Purchaser 5 receives $175,000−$148,500 (the loan is paid in full) or $26,500 from his comprehensive home owners insurance policy. Purchaser 5 has lost $200,000−$175,00 or $25,000 of his $50,000 downpayment. Purchaser 5 has used 1 year or 10% of his downpayment insurance. The fair market value of the home is less than the downpayment plus the loan balance (block 70), the loan balance is less than the fair market value (block 76), and the purchase price minus the fair market value is less than the downpayment (block 77). Pursuant to block 72, the equity insurance policy will pay Purchaser 5 an amount calculated as follows:

$50,000×( 9/10)−($50,000−($200,000−175,000))=$45,000−$25,000 or $20,000.

Thus, Purchaser 5 has lost only $5,000 of his $50,000 downpayment irrespective of the balance remaining on his mortgage.

The foregoing description is for purposes of illustration only and is not intended to limit the scope of protection accorded this invention. The scope of protection is to be measured by the following claims, which should be interpreted as broadly as the inventive contribution permits.

1-21. (canceled)

22. A method for protecting a purchaser's downpayment via an insurance policy for a preselected time period when purchasing a vehicle, said method comprising the steps of:
establishing a purchase price paid by a purchaser for a vehicle;
establishing a downpayment by the purchaser for the purchased vehicle;
selecting a time period for protecting the purchaser's downpayment in the purchased vehicle;
procuring an insurance policy that protects the purchaser's downpayment in the purchased vehicle during the selected time period;
establishing a date during the selected time period when the purchaser disposes of the vehicle;
determining the fair market value of the vehicle when the purchaser disposes of the vehicle during the selected time period;
calculating a loan balance for the vehicle on the date of disposition during the selected time period;
determining if the fair market value of the vehicle on the disposition date is greater than the downpayment plus the loan balance of the vehicle on the disposition date; whereupon, the purchaser is paid nothing from the insurance policy if the fair market value of the vehicle is greater than the downpayment plus the loan balance;
determining if the fair market value of the vehicle on the disposition date is greater than the downpayment plus the loan balance of the vehicle on the disposition date; whereupon, the loan balance of the vehicle on the disposition date is compared to the fair market value of the vehicle on the disposition date if the fair market value of the vehicle is less than the downpayment plus the loan balance;
determining if the loan balance of the vehicle on the disposition date is greater than the fair market value of the vehicle on the disposition date; whereupon, the purchase price of the vehicle minus the fair market value of the vehicle on the disposition date is compared to the downpayment if the loan balance is less than the fair market value;
determining if the purchase price minus the fair market value is greater than the downpayment; whereupon, the procured insurance policy pays the purchaser a first calculated amount if the purchase price minus the fair market value is less than the downpayment;
determining if the purchase price minus the fair market value is greater than the downpayment; whereupon, the procured insurance policy pays the purchaser a second calculated amount if the purchase price minus the fair market value is greater than the downpayment; and
determining if the loan balance of the vehicle on the disposition date is greater than the fair market value of the vehicle on the disposition date; whereupon, the procured insurance policy pays the purchaser a second calculated amount if the loan balance is greater than the fair market value.

23. The method of claim 22 wherein said first calculated amount includes the step of paying the purchaser an amount calculated as follows:
Downpayment×(time period remaining on equity insurance policy/selected time period for equity insurance policy)−(Downpayment−(Purchase Price−Fair Market Value))

24. The method of claim 22 wherein said second calculated amount includes the step of paying the purchaser an amount calculated as follows:
Downpayment×(time period remaining on equity insurance policy/selected time period for policy)

25. The method of claim 22 wherein the step of procuring an insurance policy includes the step of determining what portion of the purchaser's downpayment will be paid to the purchaser.

26. The method of claim 25 wherein the step of determining what portion of the purchaser's downpayment will be paid includes the step of selecting a valuation algorithm for the selected time period.

27. The method of claim 26 wherein said algorithm provides an amount greater than purchaser's downpayment for the selected time period.

28. The method of claim 26 wherein said algorithm provides an amount equal to purchaser's downpayment for the selected time period.

29. The method of claim 26 wherein said algorithm provides an amount less than purchaser's downpayment for the selected time period.

30. The method of claim 29 wherein said algorithm provides an amount that decreases on a prorated basis over the selected time period.

31. the method of claim 29 wherein said algorithm provides an amount that decreases on an accelerated basis over the selected time period.

32. A method for compensating a buyer of goods for equity lost in the goods during a predetermined time period, said method comprising the steps of:
establishing a purchase price paid by a buyer of goods;
establishing a buyer's equity in the goods on the purchase date;
selecting a time period for compensating the buyer for lost equity in the goods in the event the goods are sold, lost, stolen, damaged or otherwise disposed of;
procuring an insurance policy that compensates the buyer for lost equity in the purchased goods over the selected time period, said insurance policy including a computerized compensation table establishing the amount the buyer receives relative to the disposition day of the goods during said selected time period, said insurance policy including the premiums paid by the purchaser for receiving said compensation;
establishing a date during selected time period when the buyer disposes of the goods during the selected time period;
determining the fair market value of the goods when the buyer disposes of the goods during the selected time period;
calculating a loan balance for the goods on the date of disposition during the selected time period;
determining if the fair market value of the goods on the disposition date is greater than the equity plus the loan balance of the goods on the disposition date; whereupon, the buyer is paid nothing from the insurance policy if the fair market value of the goods is greater than the equity plus the loan balance;
determining if the fair market value of the goods on the disposition date is greater than the equity plus the loan balance of the goods on the disposition date; whereupon, the loan balance of the goods on the disposition date is compared to the fair market value of the goods on the disposition date if the fair market value of the goods is less than the equity plus the loan balance;
determining if the loan balance on the goods on the disposition date is greater than the fair market value of the goods on the disposition date; whereupon, the purchase price of the goods minus the fair market value of the goods on the disposition date is compared to the equity if the loan balance is less than the fair market value;
determining if the purchase price minus the fair market value is greater than the equity; whereupon, the procured insurance policy pays the buyer a first calculated amount if the purchase price minus the fair market value is less than the equity;
determining if the purchase price minus the fair market value is greater than the equity; whereupon, the procured insurance policy pays the buyer a second calculated amount if the purchase price minus the fair market value is greater than the equity; and
determining if the loan balance of the goods on the disposition date is greater than the fair market value of the goods on the disposition date; whereupon, the procured insurance policy pays the buyer a second calculated amount if the loan balance is greater than the fair market value.

33. The method of claim 32 wherein said first calculated amount includes the step of paying the buyer an amount calculated as follows:
Equity×(time period remaining on equity insurance policy/selected time period for equity insurance policy)−(Equity−(Purchase Price−Fair Market Value))

34. The method of claim 32 wherein said second calculated amount includes the step of paying the buyer an amount calculated as follows:
Downpayment×(time period remaining on equity insurance policy/selected time period for policy)

35. The method of claim 32 wherein the step of procuring an insurance policy includes the step of selecting a valuation algorithm for said selected time period.

36. The method of claim 35 wherein said algorithm provides an amount greater than buyer's initial equity established on the purchase date, said algorithm providing a greater amount for the selected time period.

37. The method of claim 35 wherein said algorithm provides an amount equal to buyer's initial equity on the purchase date, said algorithm providing an equal amount for the selected time period.

38. The method of claim 35 wherein said algorithm provides an amount less than buyer's initial equity established on the purchase date, said algorithm providing a less amount for the selected time period.

39. The method of claim 38 wherein said algorithm provides an amount that decreases on a prorated basis over the selected time period.

40. The method of claim 38 wherein said algorithm provides an amount that decreases on an accelerated basis over the selected time period.

41. A method for insuring a purchaser's initial payment to procure an item to be paid for over a selected time period, said method comprising the steps of:
establishing an initial payment amount paid by the purchaser for a purchased item;
selecting a time period for protecting the purchaser's initial payment for the purchased item;
establishing a date during the selected time period when the purchaser disposes of the vehicle;
determining the fair market value of the item when the purchaser disposes of the item during the selected time period;
calculating a loan balance for the item on the date of disposition during the selected time period;
procuring an insurance policy that compensates the purchaser for a calculated portion of said initial payment in the event the item is disposed of during said selected time period;
determining if the fair market value of the item on the disposition date is greater than the initial payment plus the loan balance of the item on the disposition date; whereupon, the purchaser is paid nothing from the insurance policy if the fair market value of the item is greater than the initial payment plus the loan balance;
determining if the fair market value of the item on the disposition date is greater than the initial payment plus the loan balance on the item on the disposition date; whereupon, the loan balance of the item on the disposition date is compared to the fair market value of the item on the disposition date if the fair market value of the item is less than the initial payment plus the loan balance;
determining if the loan balance of the item on the disposition date is greater than the fair market value of the item on the disposition date; whereupon, the purchase price of the item minus the fair market value of the item on the disposition date is compared to the initial payment if the loan balance is less than the fair market value;
determining if the purchase price minus the fair market value is greater than the initial payment; whereupon, the procured insurance policy pays the purchaser a first calculated amount if the purchase price minus the fair market value is less than the initial payment;
determining if the purchase price minus the fair market value is greater than the initial payment; whereupon, the procured insurance policy pays the purchaser a second calculated amount if the purchaser minus the fair market value is greater than the initial payment; and
determining if the loan balance of the item on the disposition date is greater than the fair market value of the item on the disposition date; whereupon, the procured insurance policy pays the purchaser a second calculated amount if the loan balance is greater than the fair market value.
